(19) United States
(12) Patent Application Publication
(10) Pub. No.: US 2012/0073676 A1
(43) Pub. Date: Mar. 29, 2012

(54) Device and Process for Removing Screenings from Liquid Flowing in a Channel

(75) Inventors: Christian Frommann, Neumarkt (DE); Franz Spenger, Rottenbach (DE); Stefan Reber, Numberg (DE)

(73) Assignee: Huber SE, Berching (DE)

(21) Appl. No.: 13/238,474

(22) Filed: Sep. 21, 2011

(30) Foreign Application Priority Data
Sep. 24, 2010 (DE) 10 2010 041 312.7

(51) Int. Cl. F15D 1/00

(52) U.S. Cl. 137/315.01

(57) ABSTRACT

The invention refers to a device for removing screenings from liquid flowing in a channel (1), especially from sewage (2), the device comprising a tilted screening drum (4) being at least partly immersed in the liquid, being drivable around a rotating axis with the help of a drive and having an open face (5) on the inflow side, the device further comprising an extractor for the screenings, preferably in form of a screw conveyor (11) or suction device (17), whereas the extractor is arranged at least partially inside the screening drum (4) and comprises a feeding section for the screenings, preferably in form of a feeding funnel (15), that is arranged inside the screening drum (4). According to the invention, it is suggested for the screening drum (4) to have a folded sieve wall (19).

This invention refers to a device for removing screenings from liquid flowing in a channel, especially from sewage, with a tilted screening drum that is at least partly immersed in the liquid, that can be driven around a rotating axis with the help of a drive, that comprises an open face on the inflow side, and that is equipped with an extractor having the preferred shape of a screw conveyor or suction device for the screenings, whereas the extractor is arranged at least partially inside the screening drum, in which case the extractor within the screening drum comprises a feeding section, preferably in form of a feeding funnel for the screenings.

A corresponding device is known from DE 34 20 157 C1, for example. The installation described therein is equipped with a sieve grate that is shaped like a cylinder jacket and placed with its axis diagonally in a channel, whereas the sieve grate is hydraulically open at its inflow side and more or less hydraulically closed at its outflow side. Preferably, the sieve grate has slot perforations that form a separation surface on the inner side so that liquid flows through the slots and remains in the channel. The sieve grate is rotatingly driven in connection with a screw conveyor that starts in a feeding funnel that is coaxially arranged and mounted in a fixed position in the sieve grate area. Above the feeding funnel, on the outer side of the sieve grate, a separating device shaped like a brush roller or spraying water strip arranged in fixed position is provided for removing the screenings that are located on the inner side of the sieve grate. The screenings finally fall into the feeding funnel at which the screw conveyor begins. The latter transports them away to a dropping point outside the liquid.

Even if the known filtration plants already have considerable filtering capacity, it is still nonetheless worthwhile to increase the performance of similar installations or modify them in such a way that a certain filtering performance can be achieved with a smaller device.

The task of this invention is therefore to create a screening or filtering plant for removing screenings from liquid flowing in a channel such as a sewer, for example, characterized by a particularly high filtering capacity with regard to its dimensions.

The task is solved by a device according to claim 1. According to the invention, the device is characterized by a screening drum with a folded sieve wall. In this way, provided that the screening drum diameter remains the same, it is possible to provide a much higher active screening surface compared to the surfaces known from conventional screening drums, which have a smooth screening surface. Another advantage of the folding according to the invention is the fact that the impurities held back from the liquid to be filtered start accumulating in the inner recesses created by the folding and are transported upwards through the screening drum's rotation. In this case, even if additional conveyor troughs could be provided, they are actually not needed. Last but not least, the folding of the screening surface increases the screening drum's stability. As a result, the screening drum can be made self-supporting.

In this case, it is especially advantageous for the sieve wall to be folded in a zigzag, a wavelike or a stepped way so that sieve wall valleys alternate with sieve wall mountains. Generally, it should be remembered here that the term “folded” should not be restrictively interpreted in this context; in other words, there do not have to be kinks in the edges as known from concertinas. Thus, it can be really advantageous for the screening drum to have a wavy cross-section because in this case no sharp-cornered sections are created to which more impurities could possibly adhere. In principle, the invention is therefore not restricted to a certain surface deformation of the screening drum. Rather, it comprises all screening drums that—contrary to those having a smooth screening surface—have recesses and elevated areas resulting in the screening surface being larger than the one in a smooth screening drum of the same diameter. Additionally, the folding of the screening drum does not have to extend over the entire screening surface section. Thus, with regard to the channel, it is for example conceivable to fold only the lower section. The same applies to the upper section or also to sections located in between. It could also be possible to alternate folded and unfolded sections in a rotational direction, whereas the type, size and distribution is chosen dependent on the corresponding use of the plant.

It is also advantageous for the sieve wall to be made, at least partly, of metal with many perforations, for example in form of a perforated or slotted sheet or a mesh fabric that is preferably supported by means of a carrying structure. In this way, the installation with the screening drum can be used for a variety of filtering tasks, in which case the diameter of the separation surface openings through which the liquid can run off can range from a few μm to several cm. Likewise, plastic filtering and screening materials can be used, and in this case all separation surfaces can either be self-supporting or supported by a supporting structure.

It is also extremely advantageous if the sieve wall valleys and sieve wall mountains run parallel, skewed or radially to the rotating axis of the screening drum. While a parallel orientation facilitates very simple manufacturing, a skewed or a helical-shaped line orientation can have a positive influence on the conveying effect of the retained impurities described above. Contrary to this, there is only a slight conveying effect caused by a radial course of the sieve wall valleys and mountains. Nonetheless, in this case there is also an enlargement of the available sieve surface. Naturally, various courses can also be combined, so that surfaces with a parallel orientation alternate with sections having a radial orientation, for example.

It is furthermore advantageous for the screening drum to have a reinforcing element, at least on a frontal side. While the screening drum already gets a higher stiffness due to the folding compared to the state of the art, the additional reinforcing elements ensure that the screening drum will maintain its shape even under the toughest conditions, such as during the removal of stones or other large or sharp impurities. In this case, the reinforcing elements can be ribbon-shaped, placed around the screening drum's external side and connected to it, for example. Other internal reinforcing elements that are shaped like carrier bars running parallel to the rotation axis, for example, are also conceivable that bring about or support the transportation of the impurities to the upper dropping point of the screening drum.

It is also advantageous for the reinforcing element to be designed as a reinforcing ring. In this case, such a ring can be arranged either in the frontal side areas or in the section of the screening drum lying in between. If the ring or several rings are arranged in the area of the frontal sides, then it is advantageous to connect them to the outer edge of the folded screening drum in such a way that no unfiltered liquid can flow out between the ring and the screening surface.

It is also extremely advantageous if the reinforcing ring has a centric opening with a diameter that is smaller than or equal to the smallest inner diameter of the screening drum. As a result, openings in the screening drum located between the screening surface and the centric opening that would allow a passage of impurities can be prevented.

It is advantageous for the screening drum to have at least one (for example, ring-shaped) flange with which it can be operationally connected to the drive. This connection can be implemented for example by means of a driving arm, which in turn can be linked to the motor through a screw conveyor. The flange can also serve as adapter between the screening drum and the remaining installation (for example, the mentioned driving arm) so that different screening drums can be easily and quickly replaced.

It is especially advantageous if the radial distance between the screening drum's minimal and maximal diameters is smaller than or equal to the ring width of the reinforcing ring or smaller than or equal to the radial extension of the flange with regard to the rotational axis of the screening drum. While the reinforcing ring or flange in the last mentioned case basically covers the cross-section of the screening surface running parallel to the rotating axis of the screening drum, an edge is formed when the opening is smaller. In this case the edge extends inwards and with respect to a radial direction beyond and above the individual folds of the screening drum. Since the liquid flowing into the channel must pass through this edge, said opening should not be too small.

Additional advantages are gained if the flange is connected with the reinforcing element, in which case a seal is preferably arranged between the flange and the reinforcing element. In this case, the screening drum consists of the folded sieve wall according to the invention with the sieve wall having a reinforcing ring, preferably in the area of both frontal sides. In this way, a screening drum is obtained that can be manufactured separately from the rest of the installation and safely transported. Before assembly, the screening drum is finally connected to the flange, which in turn has the corresponding fastening elements (bore holes, bolts, nuts or screwed elements) with which the flange can be connected with the screening drum and directly or indirectly with the motor of the installation. Alternatively, it is also possible to waive the flange, in which case the screening drum can be connected with the installation by means of respective fastening elements in the area of the reinforcing elements.

It is also advantageous for the external surface of the reinforcing element and/or of the flange to run flush with the screening drum's envelope. Since the screening drum has in fact been conceived for incorporation into a channel carrying a liquid, it is essential for the liquid to be able to enter the screening drum by flowing over one of the two frontal sides of the screening drum. Thus, it is advantageous if the inflow edge of this frontal side can be placed as deeply as possible. This is, in turn, only possible when the reinforcing element or flange protrudes outwards, but not over the envelope (=cylinder with a diameter corresponding to the maximal diameter of the sieve wall).

It is also advantageous if the screening drum has reinforcing elements shaped especially like reinforcing strips. These elements can additionally be placed shovel-like against the sieve area, for example, in order to convey the retained impurities into the area of the discharge device. Furthermore, the reinforcing strips can be connected with the reinforcing elements, particularly with the reinforcing rings or the flanges. Additionally or alternatively, a connection with the sieve wall itself is also possible, for example, by way of welded (spot) connections between the sieve wall (e.g. in the area of the sieve wall valleys) and the reinforcing elements.

It is advantageous for the reinforcing elements to run parallel or skewed to the screening drum's rotating axis. Combinations of variously oriented reinforcing elements are possible, so that the end result is a screening drum boasting high radial and axial stability.

It is also advantageous if the reinforcing elements are connected, preferably welded, to the sieve wall and/or at least to one reinforcing element and/or a flange, so that the screening drum will consequently have a stable frame capable of withstanding extremely large stresses.

Last but not least, it is also advantageous if the ratio between the number of sieve wall folds and the screening drum's diameter lies within the range of 40/m to 180/m. These values have proven to be especially favorable in practice, because in this area—with justifiable added cost—a significant enlargement of the screening surface and of the plant's filtering efficiency can be achieved compared to a smooth screening surface.

The embodiments below describe more advantages of the invention. They show:

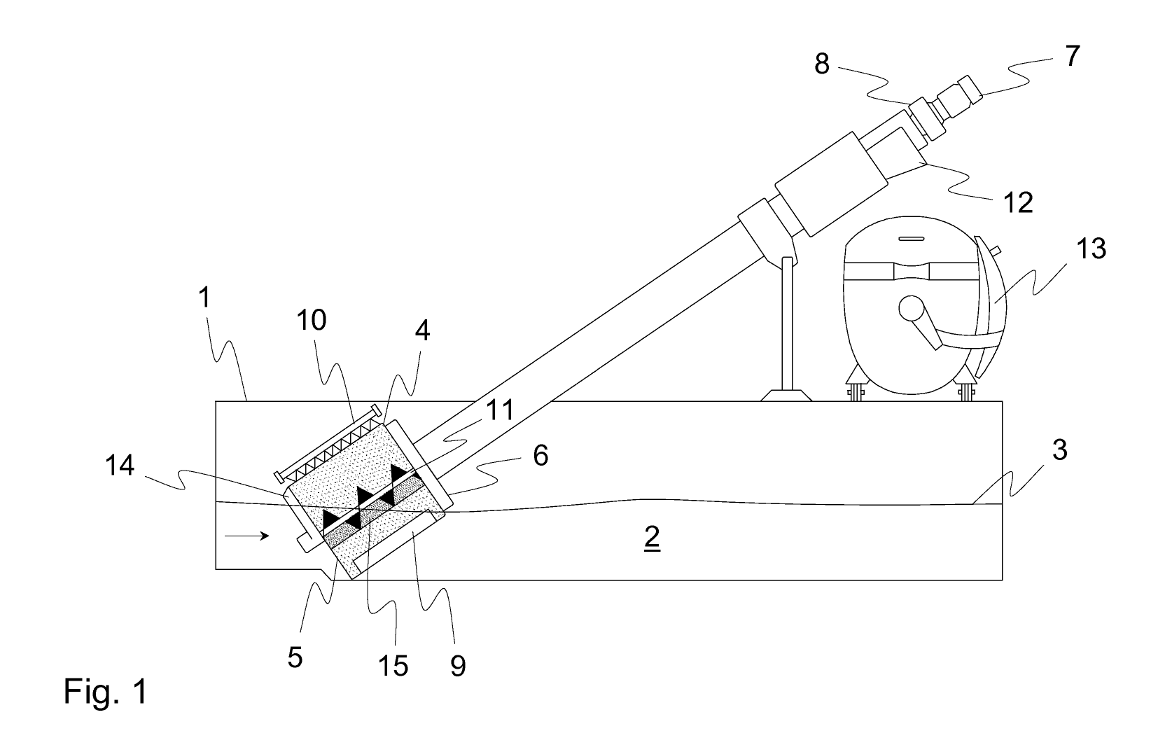

FIG. 1 a side view of a screening device according to the state of the art,

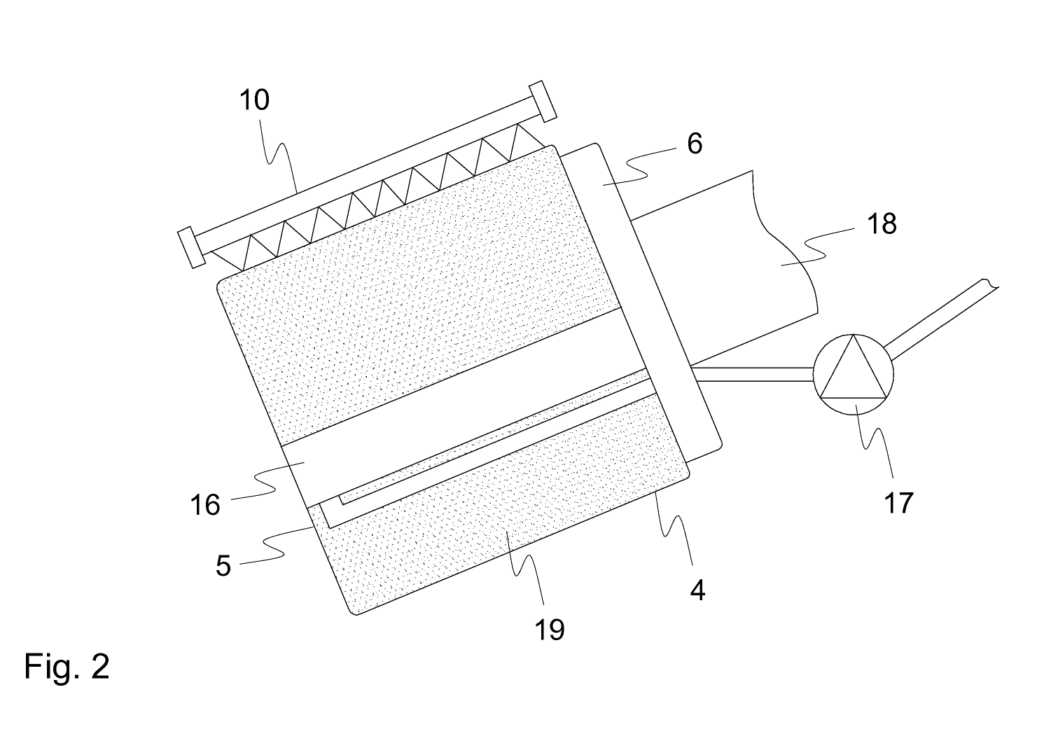

FIG. 2 a side view of a section of another screening device,

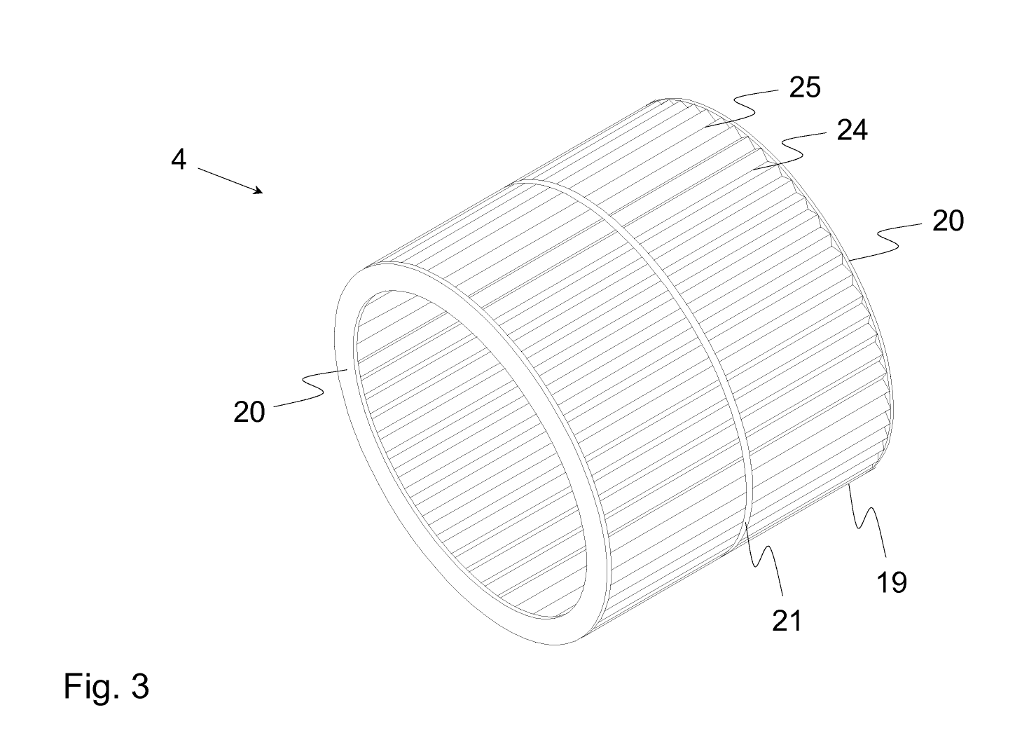

FIG. 3 a perspective view of a screening drum according to the invention,

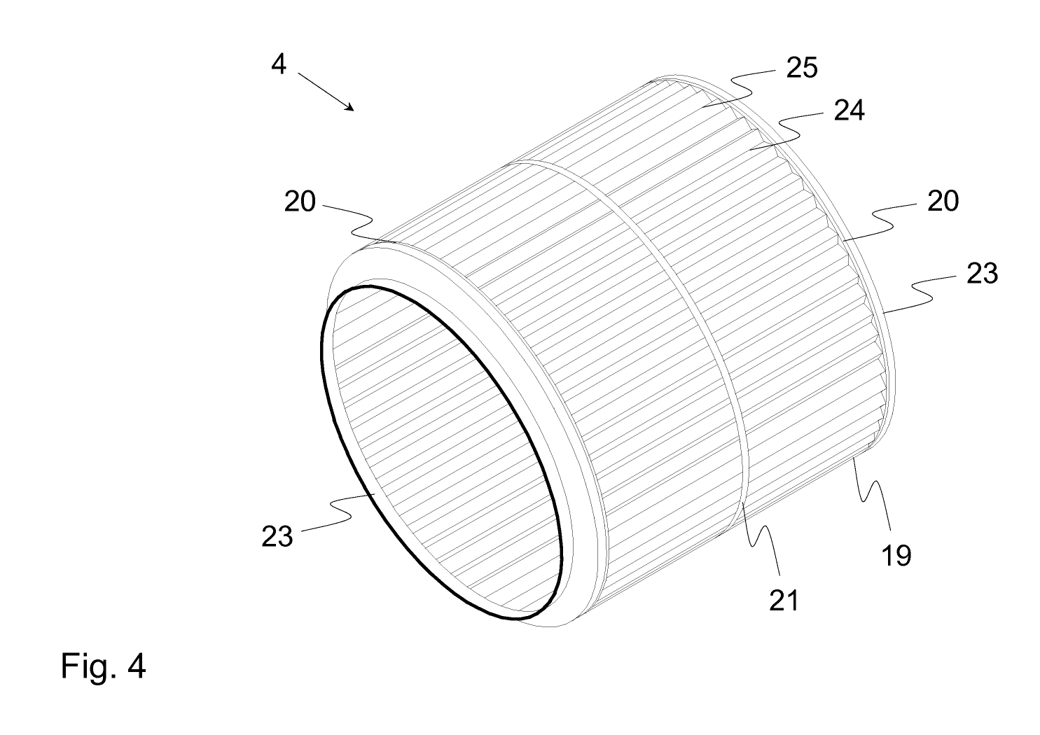

FIG. 4 a perspective view of the screening drum according to FIG. 3 with flanges placed upon it,

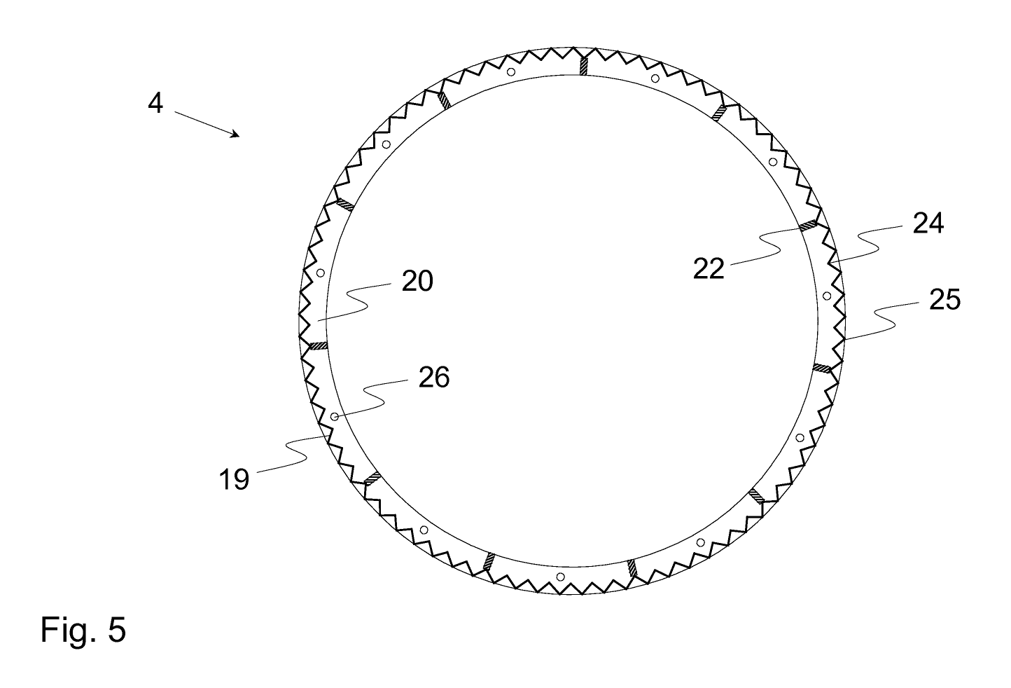

FIG. 5 a sectional view of a screening drum,

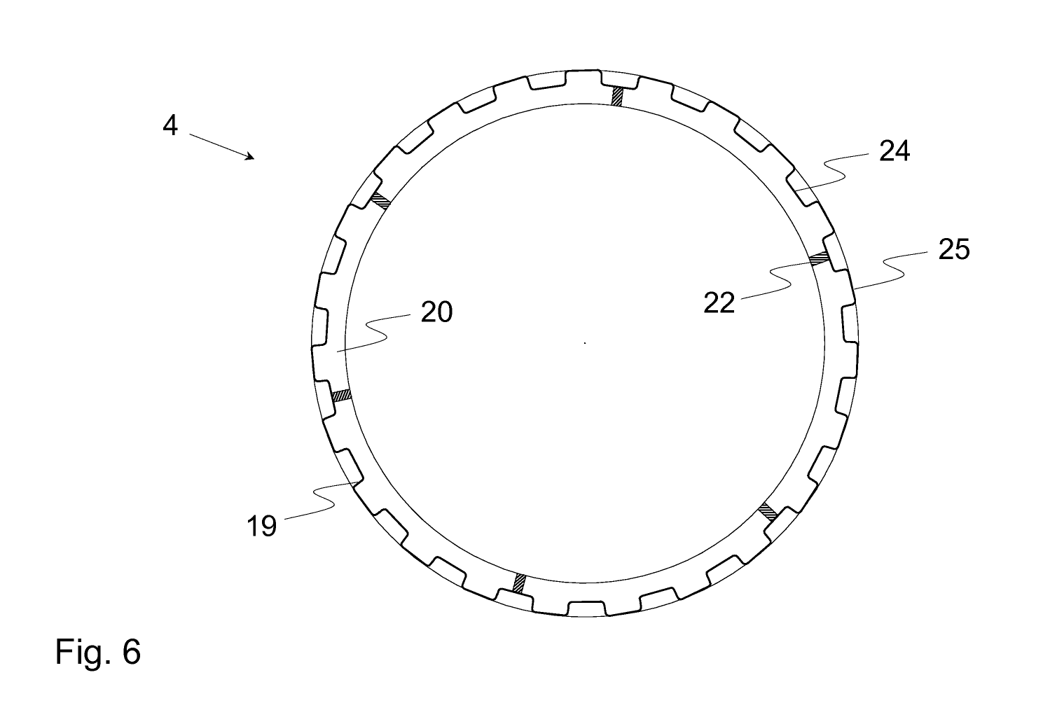

FIG. 6 a sectional view of an alternative embodiment of a screening drum according to the invention, and

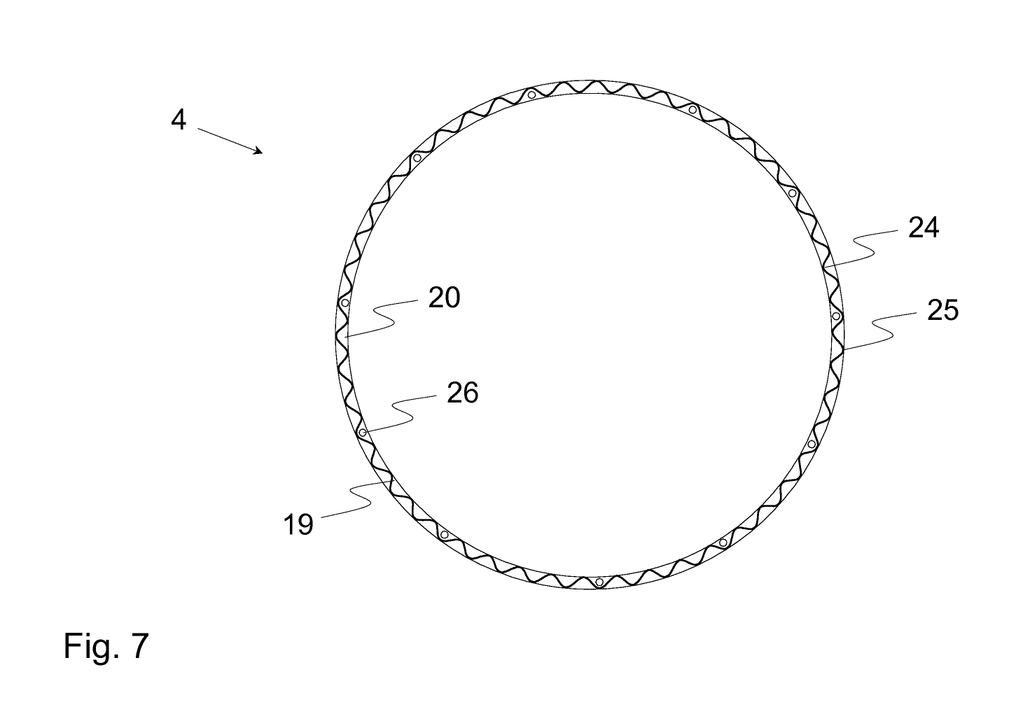

FIG. 7 another sectional view of a screening drum according to the invention.

First of all, it should be noted that in figures showing several similar components or sections, only one of these is provided with its reference symbol for ensuring a good overview.

FIG. 1 shows a portion of a channel 1, into which sewage 2 contaminated with screenings with a generally variable water level 3 flows in the direction of the arrow. The axis of the screening device arranged therein is tilted with respect to the channel 1, whereas there can be a corresponding seal (not shown) between the channel 1 and the device so that the dirty sewage 2 cannot pass through the device without being filtered.

The device itself comprises a cylinder jacket-shaped sieve element in form of a cylindrical screening drum 4 (partly cut in FIG. 1 so one can see its interior) whose screening surface can consist, for example, of perforated or slotted sheet metal or also of mesh fabric preferably supported by a carrying basket.

On the inflow side, the screening drum 4 has an open frontal side 5 through which the dirty sewage 2 can flow into the interior of the screening drum 4. On the outflow side, a sealed and thus hydraulically closed frontal side 6 is provided.

During filtration, the screening drum 4 is set in rotational motion with the help of a motor 7 and advantageously through a gear 8. The screenings held back by the filtering surface are retained by the filtering surface and finally conveyed upwards by the rotating movement, in which case the screening drum 4 can have carrier bars 9.

Finally, a spraying nozzle 10 has been placed in the upper area for detaching the adhering screenings so that they can drop into a feeding funnel and be moved to the discharge device section that is shaped like a screw conveyor 11 (naturally, air nozzles, scrapers or brush elements can be placed there instead of the spraying nozzle 10).

The screw conveyor 11 finally extends all the way to the area of a dropping point 12 in the upper section of the screening device so that the screenings are transported upwards for final disposal in the corresponding container 13. The screw conveyor 11 can have a dwindling screw height in the course of the conveying path for additional compression of the screenings within the upper conveying section.

The screw conveyor 11 is generally driven discontinuously, so that stoppages alternate with revolution times. Finally, for transferring the rotational movement of the motor 7 to the screening drum 4, a driving arm 14 has been provided at the lower end of the worm shaft for connecting the worm shaft with the screening drum 4.

The screening drum 4 according to the invention also has significant advantages over the state of the art in the filtration of particularly fine screenings. Thus, the screening drum 4 described in more detail below can also be installed, for example, in plants equipped with a suction device 17 (such as the one shown in FIG. 2) instead of a screw conveyor 11 (which might be incapable of discharging very fine screenings). In this case, the rotation of the screening drum 4 is realized via a driving axis 18, which is in turn connected with a motor 7. The screenings that also collect on the rotating inner surface of the screening drum 4 in such screening devices are, in turn, removed from the screening surface with the help of a spraying nozzle 10, for example. Finally, the screenings arrive at a retention device 16 in form of a trough that is located inside the filtering element. The screenings and the spray water finally form a suspension that can be sucked off with the suction device 17 and processed further. The retention device 16 can have a U-shaped or semicircular cross-section, for example, and can be arranged in the area of the rotating axis of the screening drum 4.

FIG. 3 shows a perspective view of a screening drum 4 according to the invention that can be used in a plant according to the description of the previous figures. As is readily apparent, the screening drum 4 has a cylindrical basic body consisting of the actual sieve wall 19 and the respective reinforcing elements in form of frontally attached reinforcing rings 20. Additionally or alternatively, the screening drum 4 can also have reinforcing elements in the section of the screening area. It is conceivable, for example, to have metal bands 21 placed in the area between the frontal sides that are fastened around the sieve wall 19. In addition, the corresponding rings 20 or reinforcing strips 22 can be attached to the inside of the screening drum 4 (see FIGS. 5-7). Finally, the screening drum 4, as shown in FIG. 3, forms a self-supporting unit that can therefore be easily transported and installed on site.

According to the invention, it is intended for the screening drum 4 to have a zigzag folded sieve wall 19 comprising sieve wall valleys 24 and sieve wall mountains 25. As a result, a screening surface is created with a screening area being significantly larger than the screening area of comparable screening drums that have a smooth sieve wall. While in the example shown the sieve wall valleys 24 and sieve wall mountains 25 run parallel to the centric rotating axis of the screening drum 4, another arrangement is possible in which the sieve wall valleys 24 and sieve wall mountains 25 run skewed or radially to the rotating axis of the screening drum 4, i.e. parallel to the metal band 21 shown.

FIG. 4 shows a screening drum 4 according to the invention as described in connection with FIG. 3, in which case additional flanges 23 have been attached in the frontal side area. The flanges 23, which can be screwed, welded, glued or even riveted to the reinforcing rings 20, serve to additionally stabilize the sieve wall 19 and also provide a link to the driving arm 14, which is in turn connected with a motor 7 (see FIG. 1). By choosing the corresponding flange 23, the screening drum 4 can finally be installed in various filtering plants to further widen its applicability. In this case, the driving arm 14 can be detachably or fixedly connected with the flange 23 (with a welded joint, for example). The flange 23 can also include a respective driving arm 14 so that no additional connection is needed.

As already mentioned, reinforcing strips 22 can also be arranged inside the screening drum 4. Preferably, they extend between both frontal sides of the screening drum 4 and can be connected with the reinforcing rings 20 or the flange(s) 23 on the frontal sides to finally serve as stabilizers of the sieve wall 19. In addition, they can also take over the function of the carrier bars 9 as already described in connection with FIG. 1. A cross-section of a screening drum 4 according to the invention, that shows the location of the reinforcing strips 22 , is shown in FIGS. 5 & 6. As can be seen, the reinforcing strips 22 are connected with the sieve wall 19 through welding spots, for example, and with the back reinforcing ring 20. In this case, the reinforcing ring 20 can protrude the folding in the direction of the rotating axis or, as can be seen in FIG. 7, end flush with it.

Additionally, the reinforcing rings 20 have bore holes 26, through which the screening drum 4 can be connected with a corresponding flange 23, driving arm 14 or other plant parts.

Finally, it is apparent from FIGS. 5-7 that the screening drum 4 must not necessarily be folded in zigzag. Stepped (FIG. 6) or wave-like (FIG. 7) folds are conceivable.

Likewise, the sieve wall 19 can already be built as a self-supporting structure, so that the additional reinforcing elements are not necessary (FIG. 7).

Incidentally, the invention is not restricted to the embodiments shown. Rather, all combinations of the described individual characteristics as shown or described in the claims, the description and the figures, are the object of the invention as far as the corresponding combination is technically feasible or seems meaningful.

### LIST OF REFERENCE SYMBOLS

1 Channel

2 Sewage

3 Water level

4 Screening drum

5 Open frontal side

6 Closed frontal side

7 Motor

8 Gear

9 Carrier bar

10 Spray nozzle bar

11 Screw conveyor

12 Dropping point

13 Container

14 Driving arm

15 Feeding funnel

16 Retention device

17 Suction device

18 Driving axis

19 Sieve wall

20 Reinforcing ring

21 Metal band

22 Reinforcing strip

23 Flange

24 Sieve wall valley

25 Sieve wall mountain

26 Bore hole

1. Device for removing screenings from liquid flowing in a channel (1), especially from sewage (2), the device comprising a tilted screening drum (4) being at least partly immersed in the liquid, being drivable around a rotating axis with the help of a drive and having an open face (5) on the inflow side, the device further comprising an extractor for the screenings, preferably in form of a screw conveyor (11) or a suction device (17), whereas the extractor is arranged at least partially inside the screening drum (4) and comprises a feeding section for the screenings, preferably in form of a feeding funnel (15), that is arranged inside the screening drum (4), characterized in that the screening drum (4) has a folded sieve wall (19).

2-15. (canceled)
